(19) United States
(12) Patent Application Publication
(10) Pub. No.: US 2005/0159942 A1
(43) Pub. Date: Jul. 21, 2005

(54) Classification of speech and music using linear predictive coding coefficients

(76) Inventor: Manoj Singhal, Bangalore (IN)

Correspondence Address: CHRISTOPHER C. WINSLADE;MCANDREWS HELD & MALLOY, 500 WEST MADISON STREET, 34TH FLOOR, CHICAGO, IL, 60661, US

(21) Appl. No.: 10/757,791

(22) Filed: Jan. 15, 2004

(51) Int. Cl. G10L 19/04

(52) U.S. Cl. 704/219

(57) ABSTRACT

Presented herein are systems and methods for classifying an audio signal. The audio signal is classified by calculating a plurality of linear prediction coefficients (LPC) for a portion of the audio signal; inverse filtering the portion of the audio signal with the plurality of linear prediction coefficients (LPC), thereby resulting in a residual signal; measuring the residual energy of the residual signal; and comparing the residual energy to a threshold.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

Human beings, with normal hearing, are often able to distinguish sounds from about 20 Hz, such as the lowest note on a large pipe organ, to 20,000 Hz, such as the high shrill of a dog whistle. Human speech, on the other hand, ranges from 300 Hz to 4,000 Hz.

Music may be produced by playing musical instruments. Musical instruments often produce sounds that lie outside the range of human speech, and in many instances, produce sounds (overtones, etc.) that lie outside the range of human hearing.

An audio communication can comprise either music, speech or both. However, conventional equipment processes audio communication signals comprising only speech in a similar manner as communication signals comprising music.

Further limitations and disadvantages of conventional and traditional approaches will become apparent to one of skill in the art, through comparison of such systems with embodiments presented in the remainder of the present application with references to the drawings.

### SUMMARY OF THE INVENTION

Presented herein are systems and methods for classifying an audio signal.

In one embodiment of the present invention, there is presented a method for classifying an audio signal. The method comprises calculating a plurality of linear prediction coefficients for a portion of the audio signal; inverse filtering the portion of the audio signal with the plurality of linear prediction coefficients filter, thereby resulting in a residual signal; measuring the energy of the residual signal; and comparing the residual energy to a threshold.

In another embodiment, the method further comprises classifying the portion of the audio signal as music, if the residual energy exceeds the threshold; and classifying the portion of the audio signal as speech, if the threshold exceeds the residual energy.

In another embodiment, the portion of the audio signal comprises a frame.

In another embodiment, the method further comprises decimating the frame, thereby causing the frame to comprise a predetermined number of samples.

In another embodiment, the method further comprises spectrally flattening the portion of the audio signal.

In another embodiment, there is presented a method for classifying an audio signal.

The method comprises taking a discrete Fourier transformation of a portion of the audio signal for a plurality of frequencies; calculating a plurality of linear prediction coefficients (LPC) for the portion of the signal; measuring an inverse filter response for said plurality of frequencies with said plurality of linear prediction coefficients (LPC); measuring a mean squared error between the discrete Fourier transformation of the portion of the audio signal for the plurality of frequencies and the inverse filter response; and comparing the means squared error to a threshold.

In another embodiment, the method further comprises classifying the portion of the audio signal as music, if the mean squared error exceeds the threshold; and classifying the portion of the audio signal as speech, if the threshold exceeds the means squared error energy.

In another embodiment, the portion of the audio signal comprises a frame.

In another embodiment, the method further comprises decimating the frame, thereby causing the frame to comprise a predetermined number of samples.

In another embodiment, the method further comprises spectrally flattening the portion of the audio signal.

In another embodiment, there is presented a system for classifying an audio signal. The system comprises a first circuit, an inverse filter, a second circuit, and a third circuit. The first circuit calculates a plurality of linear prediction coefficients for a portion of the audio signal. The inverse filter inverse filters the portion of the audio signal with the plurality of linear prediction coefficients, thereby resulting in a residual signal. The second circuit measures the energy of the residual signal. The third circuit compares the residual energy to a threshold.

In another embodiment, the system further comprises logic for classifying the portion of the audio signal as music, if the residual energy exceeds the threshold, and classifying the portion of the audio signal as speech, if the threshold exceeds the residual energy value.

In another embodiment, the portion of the audio signal comprises a frame.

In another embodiment, the system further comprises a decimator for decimating the frame, thereby causing the frame to comprise a predetermined number of samples.

In another embodiment, the system further comprises a pre-emphasis filter for spectrally flattening the portion of the audio signal.

In another embodiment, there is presented a system for classifying an audio signal. The system comprises a first circuit, a second circuit, an inverse filter, a third circuit, and a fourth circuit. The first circuit takes a discrete Fourier transformation of a portion of the audio signal for a plurality of frequencies. The second circuit calculates a plurality of linear prediction coefficients (LPC) for the same portion of the signal. The inverse filter measures an inverse filter response for said plurality of frequencies with said plurality of linear prediction coefficients (LPC). The third circuit measures a mean squared error between the discrete Fourier transformation of the portion of the audio signal for the plurality of frequencies and the inverse filter response. The fourth circuit compares the means squared error to a threshold.

In another embodiment, the system further comprises logic for classifying the portion of the audio signal as music, if the mean squared error exceeds the threshold and classifying the portion of the audio signal as speech, if the threshold exceeds the means squared error energy. In another embodiment, the portion of the audio signal comprises a frame.

In another embodiment, the system further comprises a decimator for decimating the frame, thereby causing the frame to comprise a predetermined number of samples.

In another embodiment, the system further comprises a pre-emphasis filter for spectrally flattening the portion of the audio signal.

These and other advantages and novel features of the present invention, as well as details of an illustrated example embodiment thereof, will be more fully understood from the following description and drawings.

### BRIEF DESCRIPTION OF THE DRAWINGS

FIG. 1 is a flow diagram for classifying a digital audio signal as speech or music in accordance with an embodiment of the present invention;

FIG. 2 is a flow diagram for classifying a digital audio signal as speech or music in accordance with an alternative embodiment of the present invention;

FIG. 3 is a system for classifying a digital audio signal as speech or music in accordance with an embodiment of the present invention;

FIG. 4 is a system for classifying a digital audio signal as speech or music in accordance with an alternative embodiment of the present invention;

FIG. 5 is a block diagram illustrating a system for converting, classifying, encoding, and packetizing an audio communication according to an embodiment of the present invention;

FIG. 6 is a block diagram illustrating encoding of an exemplary audio signal according to an embodiment of the present invention; and

FIG. 7 is a block diagram illustrating an exemplary audio decoder according to an embodiment of the present invention.

### DETAILED DESCRIPTION OF THE INVENTION

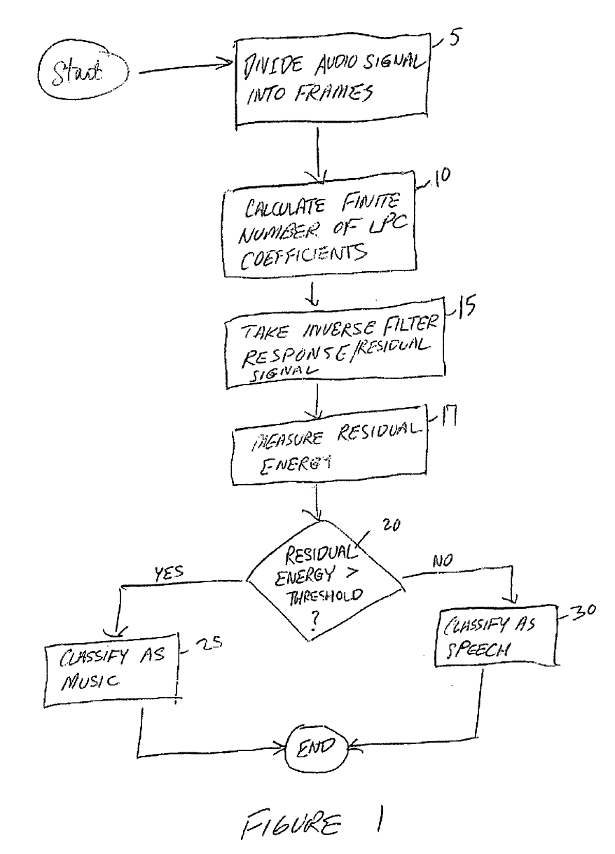

Referring now to FIG. 1, there is illustrated a flow diagram for classifying whether a digital audio signal is speech or music. At 105, the digital audio signal is divided into a set of frames. The frames comprise a fixed number of digital audio samples from the digital audio signal. Additionally, frames can be processed in a number of ways, such as by a decimator, pre-emphasis filter, or a windowing function, to name a few.

At 110, a finite number of Linear Prediction coefficients (LPC) are calculated for each frame. In general, the inherent limitations of the human vocal tract allow a speech signal spectrum to be shaped by fewer LPC coefficients than a music signal. Accordingly, at 115 the inverse filter response of the frame to an inverse filter according to the LPC coefficients (the residual signal) calculated during 110 is taken and the residual energy is measured at 117. The residual energy of the filter response is compared at 120 to an energy threshold.

If the residual energy exceeds the threshold, at 120, the frame is classified (125) as music. If the residual energy does not exceed the threshold at 120, the frame is classified (130) as speech.

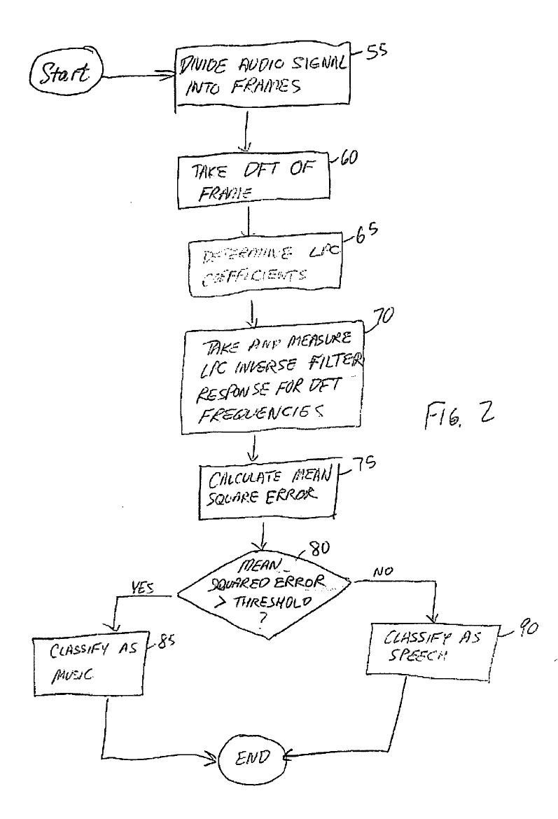

Referring now to FIG. 2, there is illustrated a flow diagram for classifying a digital audio signal as speech or music in accordance with an alternative embodiment of the present invention. At 55, the digital audio signal is divided into a set of frames. The frames comprise a fixed number of digital audio samples from the digital audio signal. Additionally, frames can be processed in a number of ways, such as by a decimator, pre-emphasis filter, or a windowing function, to name a few.

At 60, the Discrete Fourier Transformation (DFT) is taken for a frame. At 65, the LPC coefficients are determined. At 70, the LPC inverse filter response is taken and measured for the DFT frequencies. At 75, the mean squared error is calculated and compared to a threshold at 80.

If the means squared error exceeds the threshold, at 230, the frame is classified (85) as music. If the mean squared error does not exceed the threshold at 80, the frame is classified (90) as speech.

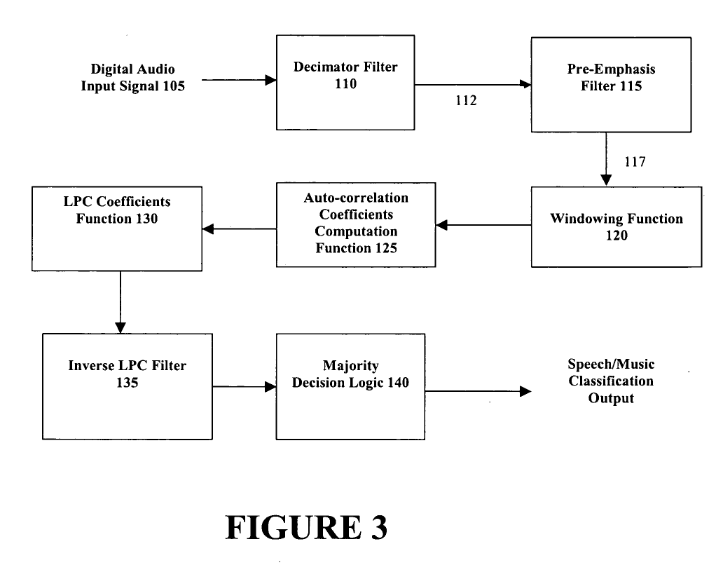

Referring now to FIG. 3, there is illustrated a block diagram describing an exemplary system for classifying a digital audio input signal 105 as speech or music. The digital audio input signal 105 can be from any real time audio source or recorded data from any other medium.

A decimator filter 110 receives the digital audio input signal 105 and divides the digital audio input signal 105 into smaller blocks containing a finite number of audio samples called a frame. The frame size depends upon the sampling rate of the digital audio input signal 105, because the decimator filter 110 provides a fixed number of samples per frame, and a fixed number of frames per second. For example, if the digital audio input signal 105 is sampled at 48000 samples/second, and the decimator filter 110 provides 50 frames comprising 160 samples, per second, the frame size can be set at 960 samples per frame, and the decimation factor set at six. The decimator filter 110 can be an adaptive filter that decimates the given audio samples appropriately in such a way that the output of the decimator filter 110 is at a fixed rate.

A pre-emphasis filter 115 receives the output 112 of the decimator filter 110. The pre-emphasis filter 115 may be a first-order finite impulse response (FIR) filter that spectrally flattens the output 112 of the decimator filter 110. The pre-emphasis filter can have the transfer function:
H(z)=1/(1+aₚᵣₑz⁻¹)

The pre-emphasis factor aₚᵣₑ can be approximately 15/16. The pre-emphasis filter 115 removes the DC component of the audio signal and helps in improving the estimation of Linear Prediction Coefficients (LPC) from auto-correlation values.

A windowing function 120 receives the output 117 of the pre-emphasis filter 115. The windowing function 120 can comprise any one of a number of different windowing standards, such as, Hamming, Hanning, Blackman, or Kaiser windows. The individual frames are windowed to minimize the signal discontinuities at the borders of each frame. If the window is defined as w[n], 0<n<N−1, then the windowed signal is s[n]=w[n]*u[n], where u[n] is the initial input data before windowing.

An auto-correlation coefficients computation function 125 receives the output of the windowing function 120. In an exemplary case, the windowed frame S comprises 160 samples, where S=(s(0), s(1) . . . s(159)). In a case where the frame comprises 160 samples, a 10^{th} order LPC coding is sufficient to model the spectrum if S is a speech signal. The signal s[n] is related to the innovation u[n] signal [The error signal between the actual signal and signal predicted using this 10^{th} order LPC coefficients] through the linear difference equation:

$$s ( n ) + {\sum }_{i = 1}^{10} {a}_{i} s ( n - i ) = u ( n )$$

These 10 LPC coefficients are chosen to minimize the energy of the innovation signal u[n]:

$$f = {\sum }_{n = 0}^{159} {u}^{2} ( n )$$

The foregoing can be determined by taking the derivative with respect to aᵢ, and setting the derivative to zero as shown below:
df/da₁=0
df/da₂=0
df/da₁₀=0

The above can be simplified to get 10 linear equations with 10 unknowns, the unknowns being the LPC coefficients. The 10 equations can be represented by the martix below:

$$[ \begin{matrix}R ( 0 ) & R ( 1 ) & R ( 2 ) & R ( 3 ) & R ( 4 ) & R ( 5 ) & R ( 6 ) & R ( 7 ) & R ( 8 ) & R ( 9 ) \\ R ( 1 ) & R ( 0 ) & R ( 1 ) & R ( 2 ) & R ( 3 ) & R ( 4 ) & R ( 5 ) & R ( 6 ) & R ( 7 ) & R ( 8 ) \\ R ( 2 ) & R ( 1 ) & R ( 0 ) & R ( 1 ) & R ( 2 ) & R ( 3 ) & R ( 4 ) & R ( 5 ) & R ( 6 ) & R ( 7 ) \\ R ( 3 ) & R ( 2 ) & R ( 1 ) & R ( 0 ) & R ( 1 ) & R ( 2 ) & R ( 3 ) & R ( 4 ) & R ( 5 ) & R ( 6 ) \\ R ( 4 ) & R ( 3 ) & R ( 2 ) & R ( 1 ) & R ( 0 ) & R ( 1 ) & R ( 2 ) & R ( 3 ) & R ( 4 ) & R ( 5 ) \\ R ( 5 ) & R ( 4 ) & R ( 3 ) & R ( 2 ) & R ( 1 ) & R ( 0 ) & R ( 1 ) & R ( 2 ) & R ( 3 ) & R ( 4 ) \\ R ( 6 ) & R ( 5 ) & R ( 4 ) & R ( 3 ) & R ( 2 ) & R ( 1 ) & R ( 0 ) & R ( 1 ) & R ( 2 ) & R ( 3 ) \\ R ( 7 ) & R ( 6 ) & R ( 5 ) & R ( 4 ) & R ( 3 ) & R ( 2 ) & R ( 1 ) & R ( 0 ) & R ( 1 ) & R ( 2 ) \\ R ( 8 ) & R ( 7 ) & R ( 6 ) & R ( 5 ) & R ( 4 ) & R ( 3 ) & R ( 2 ) & R ( 1 ) & R ( 0 ) & R ( 1 ) \\ R ( 9 ) & R ( 8 ) & R ( 7 ) & R ( 6 ) & R ( 5 ) & R ( 4 ) & R ( 3 ) & R ( 2 ) & R ( 1 ) & R ( 0 )\end{matrix} ] [ \begin{matrix}{a}_{1} \\ {a}_{2} \\ {a}_{3} \\ {a}_{4} \\ {a}_{5} \\ {a}_{6} \\ {a}_{7} \\ {a}_{8} \\ {a}_{9} \\ {a}_{10}\end{matrix} ] = [ \begin{matrix}- R ( 1 ) \\ - R ( 2 ) \\ - R ( 3 ) \\ - R ( 4 ) \\ - R ( 5 ) \\ - R ( 6 ) \\ - R ( 7 ) \\ - R ( 8 ) \\ - R ( 9 ) \\ - R ( 10 )\end{matrix} ] \\ Where \\ \begin{matrix}R ( k ) = {\sum }_{n = 0}^{159 - k} s ( n ) s ( n + k ) \\ = autocorrelation of s ( n )\end{matrix}$$

The auto-correlation coefficients computation function 125 provides the auto-correlation coefficients R(k) to the LPC coefficients computation function 130. The LPC coefficients are determined by calculating a₁, . . . a₁₀ from the above matrix. The above matrix can be solved using the Gaussian elimination method, matrix inversion, or Levinson-Durbin recursion. However, since the above matrix is a Toeplitz matrix (symmetrical & diagonals equal), the standard Levinson-Durban recursion is advantageous.

The LPC coefficients are provided from the LPC Coefficients Computation function 130 to an Inverse LPC Analysis Filter 135. The LPC analysis filter filters the input data s[n]. Since a 10^{th} order LPC filter response very closely represents the gross shape of a given input speech signal spectrum for a frame comprising 160 samples, if the given audio signal s[n] represents speech, the residual energy will be very small in comparison to the input audio signal energy. In contrast, if the given audio signal s[n] represents music, the residual energy will be significant in comparison to the input audio signal energy.

$$\begin{matrix}Input signal energy = {\sum }_{n = 0}^{n = 159} {s}^{2} [ n ] \\ Residual signal energy = {\sum }_{n = 0}^{n = 159} {r}^{2} [ n ]\end{matrix}$$

In some cases, it may not be easy to decide clearly about speech or music for a specific frame since the energy ratio value may be very close to the threshold value. In such cases, the decision may be delayed for few frames and final decision for all the frames is taken jointly depending upon the majority of the frame decisions. Each frame decision (i.e. speech or music) is taken the same way by comparing the ratio of the residual signal energy to input signal energy against the ENERGY_THRESHOLD (0.15) value for all the frames but final decision for all the audio frames is taken at the end only depending upon the majority of all the decisions.

If the ratio of residual signal energy to input signal energy is very close to the ENERGY_THRESHOLD value then decision is delayed for that frame and the same algorithm is applied to the next two or four consecutive frames depending upon the energy ratio value. Once, the individual decision is taken for all the three/five frames. With majority logic 140, whatever decisions (either speech or music) are more for all the frames, that same decision is applied to all three/five frames together.

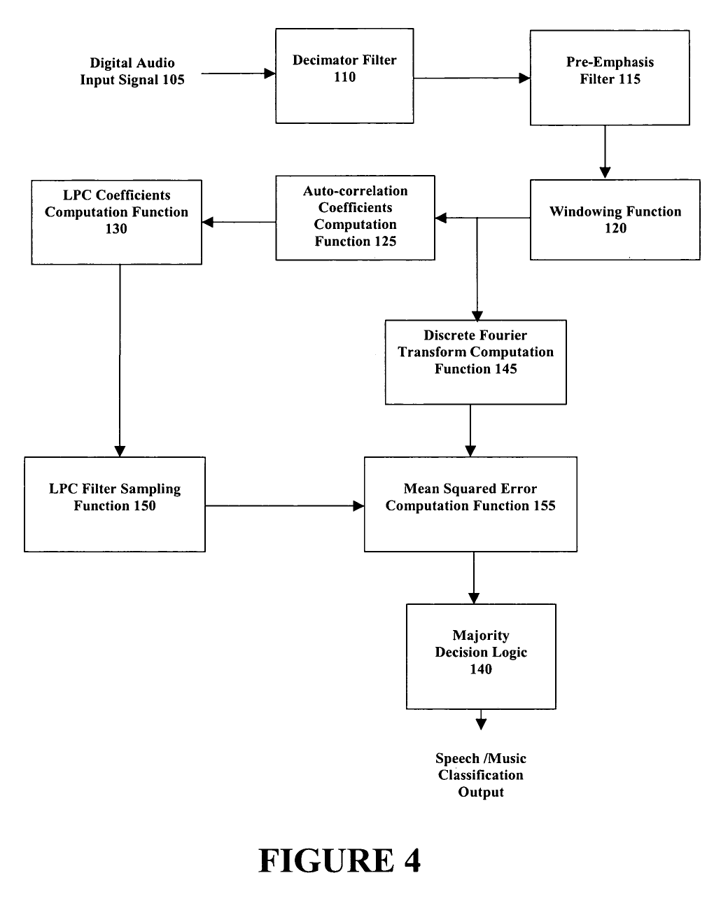

Referring now to FIG. 4, there is illustrated a block diagram of a system for classifying an input digital audio signal as music or speech in accordance with an alternative embodiment of the present invention. The Fourier transform of the given input signal s[n] is taken for a finite number of points and the magnitude of all 512 uniformly spaced frequency values are computed by a DFT function 145. The LPC filter response also at all those same 512 frequency values is sampled and the magnitude of all those 512 frequency values are computed by LPC filter sampling function 150.

With the frequency magnitudes vector for all 512 frequencies from both DFT function 145 and LPC filter sampling function 150, the mean squared error value for all the frequencies is computed by a means squared error computation function 155. Once the mean squared value is computed, the value is compared against a SQUARED_ERROR_THRESHOLD value. If the value is below that threshold value, it will be declared a speech frame, otherwise it will be declared a music frame.

$$Mean squared error = \frac{1}{512} {\sum }_{f = 0}^{f = 511} {[ S ( f ) - H ( f ) ]}^{2}$$

In some cases, it may not be easy to decide clearly about speech or music for a specific frame since the mean squared error value may be very close to the threshold value. In such cases, the decision may be delayed for few frames and final decision for all the frames is taken jointly depending upon the majority logic 140. It means that the frame decision (i.e. speech or music) is taken the same way by comparing the mean squared error value against the SQUARED_ERROR_THRESHOLD value for all the frames.

If the ratio of mean squared error value is very close to SQUARED_ERROR_THRESHOLD value then decision is delayed for that frame and the same algorithm is applied to the next two or four consecutive frames depending upon the mean squared error value. The individual decision is taken for all the three/five frames one time.

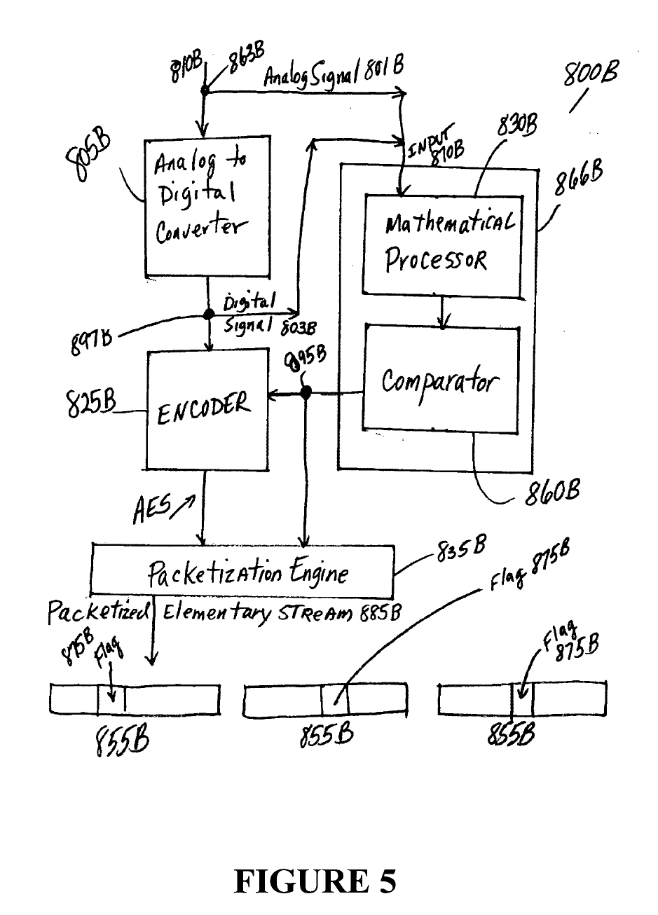

FIG. 5 is a block diagram illustrating a system 800B for converting, classifying, encoding, and packetizing an audio communication according to an embodiment of the present invention. The system 800B receives an audio communication 810B, wherein the audio communication 810B may be either an analog signal 801B or a digital signal 803B. The audio communication 810B may proceed directly to speech/music classification apparatus 866B as an analog signal 801B at junction 863B. Alternatively, the audio signal 810B may be passed through analog to digital converter 805B for conversion to a digital signal 803B that is provided via junction 797 to the speech/music classification apparatus 866B. After conversion from analog to digital, the digital signal 803B may be passed to MPEG encoder 825B. The circumstances of the audio signal processing at the MPEG encoder 852B will be described below.

The audio signal may arrive at the speech/music classifying apparatus 866B at input 820B. The signal is then passed to mathematical processor 830B. After the mathematical processing has been completed and the ratio is determined, the ratio is passed to comparator 860B. Comparator 860B is adapted to compare the calculated ratio to the threshold value. The threshold value may be pre-set by a user, or the comparator 860B may determine (learn) the threshold value through trial and error. If the ratio is greater than the threshold value, then the output from the speech/music classifying apparatus 866B is that the audio signal is determined to be music. However, if the ratio is less than the threshold value, then the output from the classifying apparatus 866B is that the audio signal is speech.

The signal may then be passed to either encoder 825B or alternatively to packetization engine 835B via junction 895B. In one embodiment, encoder 825b comprises an MPEG encoder. The encoder 825B converts the digital signal 803B to an audio elementary stream (AES), AES encoding the digital signal 803B in accordance with the MPEG standard, for example. When the AES is directed to the packetization engine 835B, the AES is packetized into a packetized audio elementary stream comprising packets 855B. Each packet comprising a portion of the AES and may also comprises a flag 875B. The flag 875B may indicate that the portion of the AES in the packet is speech or music depending upon the state of the flag 875B, i.e., whether the flag is turned on or off.

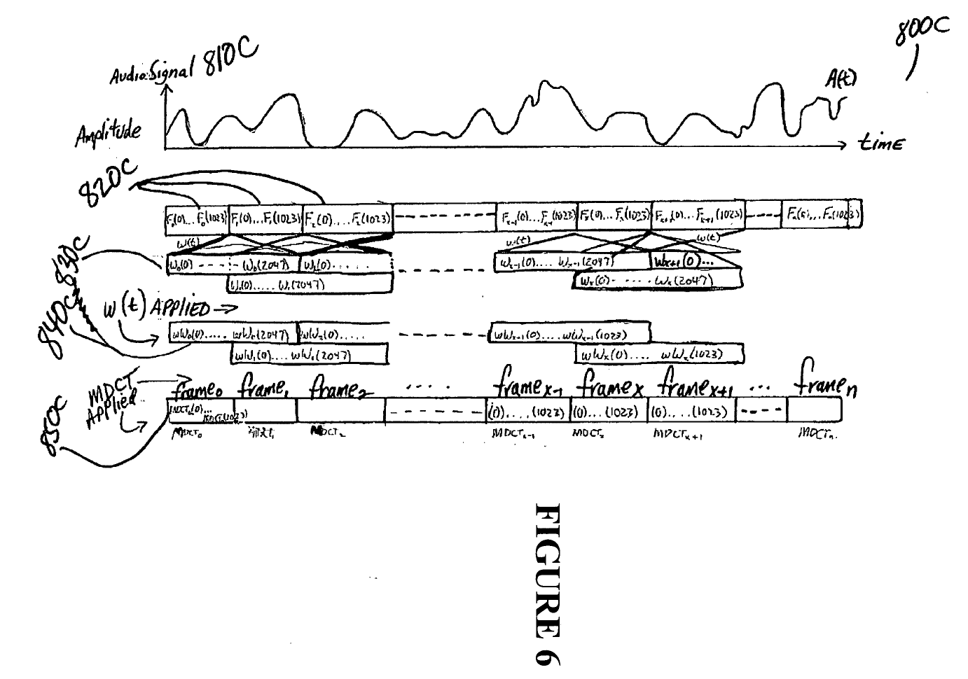

FIG. 6 is a block diagram 800C illustrating encoding of an exemplary audio signal A(t) 810C by the encoder 825B according to an embodiment of the present invention. The audio signal 810C is sampled and the samples are grouped into frames 820C (F₀ . . . Fₙ) of 1024 samples, e.g., (Fₓ(0) . . . Fₓ(1023)). The frames 820C (F₀ . . . Fₙ) are grouped into windows 830C (W₀ . . . Wₙ) that comprise 2048 samples or two frames, e.g., (Wₓ(0) . . . Wₓ(2047)). However, each window 830C Wₓ has a 50% overlap with the previous window 830C Wₓ₋₁.

Accordingly, the first 1024 samples of a window 830C Wₓ are the same as the last 1024 samples of the previous window 830C Wₓ₋₁. A window function w(t) is applied to each window 830C (W₀ . . . Wₙ), resulting in sets (wW₀ . . . wWₙ) of 2048 windowed samples 840C, e.g., (wWₓ(0) . . . wWₓ(2047)). The modified discrete cosine transformation (MDCT) is applied to each set (wW₀ . . . wWₙ) of windowed samples 840C (wWₓ(0) . . . wWₓ(2047)), resulting sets (MDCT₀ . . . MDCTₙ) of 1024 frequency coefficients 850C, e.g., (MDCTₓ(0). . . MDCTₓ(1023)).

The encoder 825B receives the output of the speech/music classification 866B apparatus. Based upon the output of the speech/music classification apparatus 866B, the encoder 825B can take any number of actions with respect to the MDCT coefficients. For example, where the output indicates that the content associated with the audio signal 810C is speech, the encoder 825B can either discard or quantize with fewer bits the MDCT coefficients associated with frequencies outside the range of human speech, i.e., exceeding 4 KHz. Where the output indicates that the content associated with the audio signal 810C is music, the MPEG 825B can quantize the MDCT coefficients associated with frequencies outside the range of human speech.

The sets of frequency coefficients 850C (MDCT₀ . . . MDCTₙ) are then quantized and coded for transmission, forming what is known as an audio elementary stream (AES). The AES can be multiplexed with other AESs. The multiplexed signal, known as the Audio Transport Stream (Audio TS) can then be stored and/or transported for playback on a playback device. The playback device can either be local or remotely located.

Where the playback device is remotely located, the multiplexed signal is transported over a communication medium, such as the Internet. During playback, the Audio TS is de-multiplexed, resulting in the constituent AES signals. The constituent AES signals are then decoded, resulting in the audio signal.

Alternatively, the frequency coefficients MDCT₀ . . . MDCTₙ may be packetized by the packetization engine of FIG. 6. In an audio signal, each frame may comprise frequency coefficients 850C (MDCT₀ . . . MDCT₁₀₂₃). Sub-frame contents may correspond to a particular range of audio frequencies.

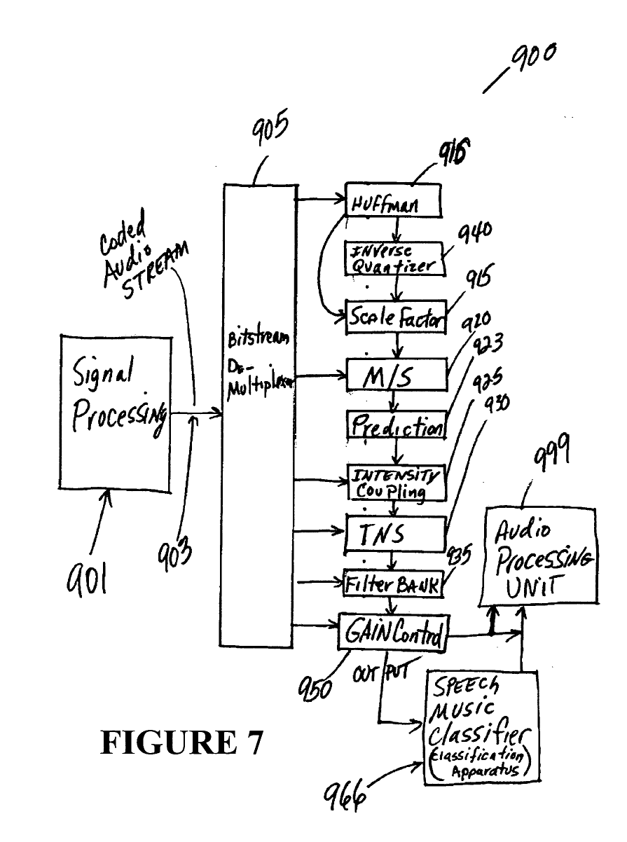

FIG. 7 is a block diagram illustrating an exemplary audio decoder 900 according to an embodiment of the present invention. Referring now to FIG. 7, once the frame synchronization is found and delivered from signal processor 901, the advanced audio coding (AAC) bit stream 903 is de-multiplexed by a bit stream de-multiplexer 905. This includes Huffman decoding 916, scale factor decoding 915, and decoding of side information used in tools such as mono/stereo 920, intensity stereo 925, TNS 930, and the filter bank 935.

The sets of frequency coefficients 850C (MDCT₀ . . . MDCTₙ) are decoded and copied to an output buffer in a sample fashion. After Huffman decoding 916, an inverse quantizer 940 inverse quantizes each set of frequency coefficients 850C (MDCT₀ . . . MDCTₙ) by a 4/3-power nonlinearity. The scale factors 915 are then used to scale sets of frequency coefficients 850C (MDCT₀ . . . MDCTₙ) by the quantizer step size.

Additionally, tools including the mono/stereo 920, prediction 923, intensity stereo coupling 925, TNS 930, and filter bank 935 can apply further functions to the sets of frequency coefficients 850C (MDCT₀ . . . MDCTₙ). The gain control 950 transforms the frequency coefficients 850C (MDCT₀ . . . MDCTₙ) into the time domain signal A(t). The gain control 950 transforms the frequency coefficients 850C by application of the Inverse MDCT (IMDCT), the inverse window function, window overlap, and window adding. The gain control 950 also looks at the flag 875B. The flag 875B is a bit that may be either on or off, i.e., having binary digital value of 1 or zero, respectively. For example, if the bit is on, this indicates that the audio signal is music, and if the bit is off, this indicates that the audio signal is speech, or vice versa.

If the flag 875B indicates that the audio signal is music the gain control and may then perform the decoding by performing the Inverse MDCT function. The gain control 950 may also report results directly to the audio processing unit 999 for additional processing, playback, or storage. The gain control 950 is adapted to detect at the receiving/decoding end of the audio transmission whether the audio signal is one of music or speech.

Another music/speech classifier 966, such as the systems disclosed in FIG. 3 or 4, may be provided at the decoder 900, so that in the circumstance where the signal has been received at the decoder 900 without being classified as one of speech or music, the signal may then be classified. The signal may also be passed to an audio processing unit 999 for storage, playback, or further analysis, as desired.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor can be implemented as part of an ASIC device with various functions implemented as firmware.

The foregoing description of the exemplary embodiment of the invention has been presented for the purposes of illustration and description. While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for classifying an audio signal, said method comprising:
Calculating a plurality of linear prediction coefficients (LPC) for a portion of the audio signal;
Inverse filtering the portion of the audio signal with the plurality of linear prediction coefficients (LPC), thereby resulting in a residual signal;
Measuring the residual energy of the residual signal; and
Comparing the residual energy to a threshold.

2. The method of claim 1, further comprising:
Classifying the portion of the audio signal as music, if the residual energy exceeds the threshold; and
Classifying the portion of the audio signal as speech, if the threshold exceeds the residual energy.

3. The method of claim 1, wherein the portion of the audio signal comprises a frame.

4. The method of claim 3, further comprising:
Decimating the frame, thereby causing the frame to comprise a predetermined number of samples.

5. The method of claim 1, further comprising:
Spectrally flattening the portion of the audio signal.

6. A method for classifying an audio signal, said method comprising:
Taking a discrete Fourier transformation of a portion of the audio signal for a plurality of frequencies;
Calculating a plurality of linear prediction coefficients (LPC) for the portion of the signal;
Measuring an inverse filter response for said plurality of frequencies with said plurality of linear prediction coefficients (LPC);
Measuring a mean squared error between the discrete Fourier transformation of the portion of the audio signal for the plurality of frequencies and the inverse filter response; and
Comparing the means squared error to a threshold.

7. The method of claim 6, further comprising:
Classifying the portion of the audio signal as music, if the mean squared error exceeds the threshold; and
Classifying the portion of the audio signal as speech, if the threshold exceeds the means squared error energy.

8. The method of claim 6, wherein the portion of the audio signal comprises a frame.

9. The method of claim 8, further comprising:
Decimating the frame, thereby causing the frame to comprise a predetermined number of samples.

10. The method of claim 6, further comprising:
Spectrally flattening the portion of the audio signal.

11. A system for classifying an audio signal, said system comprising:
A first circuit for calculating a plurality of linear prediction coefficients (LPC) for a portion of the audio signal;
An inverse filter for inverse filtering the portion of the audio signal with the plurality of linear prediction coefficients (LPC), thereby resulting in a residual signal;
A second circuit for measuring the residual energy of the residual signal; and
A third circuit for comparing the residual energy to a threshold.

12. The system of claim 11, further comprising:
Logic for classifying the portion of the audio signal as music, if the residual energy exceeds the threshold and classifying the portion of the audio signal as speech, if the threshold exceeds the residual energy.

13. The system of claim 11, wherein the portion of the audio signal comprises a frame.

14. The system of claim 13, further comprising:
A decimator for decimating the frame, thereby causing the frame to comprise a predetermined number of samples.

15. The system of claim 11, further comprising:
A pre-emphasis filter for spectrally flattening the portion of the audio signal.

16. A system for classifying an audio signal, said system comprising:
A first circuit for taking a discrete Fourier transformation of a portion of the audio signal for a plurality of frequencies;
A second circuit for calculating a plurality of linear prediction coefficients (LPC) for the portion of the signal;
An inverse filter for measuring an inverse filter response for said plurality of frequencies with said plurality of linear prediction coefficients (LPC);
A third circuit for measuring a mean squared error between the discrete Fourier transformation of the portion of the audio signal for the plurality of frequencies and the inverse filter response; and
A fourth circuit for comparing the means squared error to a threshold.

17. The system of claim 16, further comprising:
Logic for classifying the portion of the audio signal as music, if the mean squared error exceeds the threshold and classifying the portion of the audio signal as speech, if the threshold exceeds the means squared error energy.

18. The system of claim 16, wherein the portion of the audio signal comprises a frame.

19. The system of claim 18, further comprising:
A decimator for decimating the frame, thereby causing the frame to comprise a predetermined number of samples.

20. The system of claim 16, further comprising:
A pre-emphasis filter for spectrally flattening the portion of the audio signal.
